(19) United States
(12) Patent Application Publication
(10) Pub. No.: US 2018/0259091 A1
(43) Pub. Date: Sep. 13, 2018

(54) CONTROL VALVE POSITIONING SYSTEM

(71) Applicant: Hamilton Sundstrand Corporation, Charlotte, NC (US)

(72) Inventors: Robert P. Wichowski, Westfield, MA (US); Patrick J. Sears, South Hadley, MA (US); Diego S. Mugurusa, North Haven, CT (US); Timothy A. Roberts, Enfield, CT (US)

(21) Appl. No.: 15/455,174

(22) Filed: Mar. 10, 2017

(51) Int. Cl. F16K 37/00; F16K 31/04

(52) U.S. Cl. CPC F16K 37/0041; F16K 37/0033; F16K 31/043

(57) ABSTRACT

An electromechanical system has a component to be positioned, a rotary permanent magnet motor for positioning the component, and sensors for determining an apparent position of the component based upon rotation of the permanent magnets. A control counts movement of the permanent magnets that pass the sensors in a desired direction and also in an undesired direction. The control reaches an actual position of the component based upon both directions of rotation. The control also compares the actual position to an expected position of the component and identifies a need to calibrate should a difference between the actual and expected positions differ by more than a determined amount. A method is also disclosed.

### BACKGROUND OF THE INVENTION

This application relates to a system for identifying an actual position of a rotary device.

Modern systems include any number of components which are driven by rotary motors. Many of these systems require precise positioning.

Thus, it is known to develop position monitoring systems. As one example, in a brushless DC motor, it is known to provide sensors which sense rotation of the permanent magnets on a motor rotor. The motor rotor drives a shaft which, in turn, drives a component to a desired rotary position. In at least som e systems, there is a gear speed change arrangement between a first shaft driven by the motor rotor and a second shaft which drives the component.

In practice, there is the potential for a difference between a sensed position, based upon the rotation of the motor rotor, and an actual position of the component. This can occur due to backlash within the gears due to torsional spring features. In addition, the shafts have a spring like response to the torque from the motor to the component.

There are also numerous other realities within an electromechanical system which can result in the sensed position being different from an actual position. All of these issues can result in the actual component position being different from a desired component position.

Of course, this could be undesirable.

### SUMMARY OF THE INVENTION

An electromechanical system has a component to be positioned, a rotary permanent magnet motor for positioning the component, and sensors for determining an apparent position of the component based upon rotation of the permanent magnets. A control counts movement of the permanent magnets that pass the sensors in a desired direction and also in an undesired direction. The control reaches an actual position of the component based upon both directions of rotation. The control also compares the actual position to an expected position of the component and identifies a need to calibrate should a difference between the actual and expected positions differ by more than a determined amount.

A method is also disclosed.

These and other features may be best understood from the following drawings and specification.

### BRIEF DESCRIPTION OF THE DRAWINGS

FIG. 1A schematically shows an electromechanical system.

FIG. 1B shows an alternative system.

FIG. 2 is a flowchart.

FIG. 3 is a second flowchart.

### DETAILED DESCRIPTION

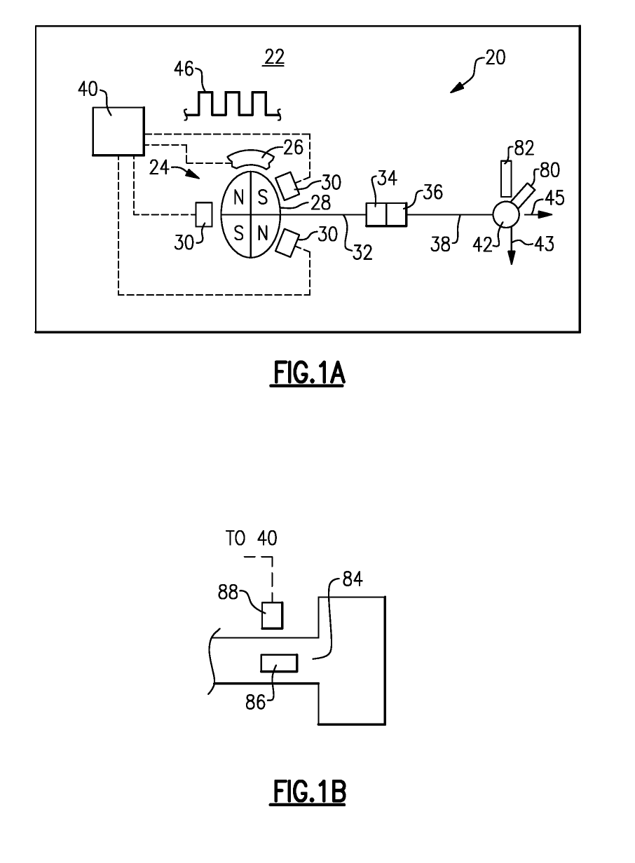

FIG. 1A shows an electromechanical system 20, which may be utilized on a space craft 22. As can be appreciated, space craft 22 operates in an environment which may be exposed to unusually high amounts of radiation. This raises challenges with regard to control systems for utilization on the space ship 22.

System 20 includes a brushless DC motor 24 having a stator 26 and a rotor 28. As known, the rotor 28 includes a plurality of permanent magnets. Sensors, which may be Hall effect sensors 30 sense the passage of each of the magnets to calculate rotation of the rotor 28. Signal pulses 46 from sensors 30 are sent to a control 40, which calculates an apparent position of an output of the brushless DC motor 24.

The rotor 28 drives a first shaft 32, which in this embodiment, drives a gear 34. Gear 34 engages and drives a gear 36 to provide a speed change between the input shaft 32 and an output shaft 38. Output shaft 38 drives the rotational position of a component 42, which may be a valve.

In one embodiment, the valve controls supply of a coolant 43 to an outlet 45 for use of the coolant on a space craft 22.

The control 40 is driving the motor stator 26 to position the valve 42 at a desired position. While a valve 42 is disclosed, other components may come within the scope of this disclosure.

As can be appreciated, it may be desirable that the position of the valve 42 be known precisely to a control 40.

Thus, it is known to take feedback of the rotation and utilize that feedback to identify an apparent position of the component 42.

However, for the reasons set forth in the background of the invention, this feedback does not always provide an accurate indication of the actual position. As an example, when the motor 28 stops, the forces in The electromechanical system can result in undesired reverse rotation.

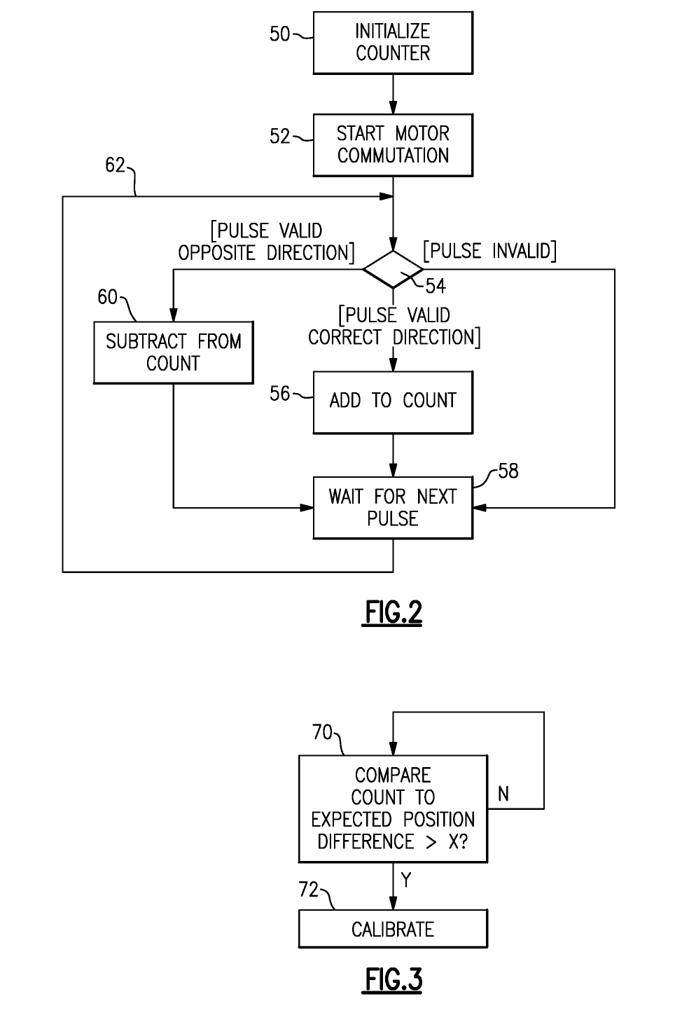

A flowchart shown in FIG. 2 improves upon this control. At step 50, a counter is initialized, such as to zero. Then at step 52, motor commutation is done in which the rotation of the permanent magnets on the rotor 28 is sensed by the several sensors 30.

Sensors send pulses 46, as shown in FIG. 1A. It is known to determine if a particular pulse is actually background noise or is an actual sensed pulse. As an example, this is disclosed in U.S. Reissue Pat. No. 45,388. Moreover, this patent discloses the basic position sensing as described. This sensing is incorporated into this application by reference.

As shown in FIG. 2, should a pulse be identified as background noise, it is deemed invalid and the method proceeds to wait for the next pulse at 58. However, should the pulse be deemed valid and in a correct or desired direction, then it is added to a count at step 56.

As mentioned above, there are a number of spring forces within the system 20 of FIG. 1. When the motor 24 is stopped, it is possible for the system spring forces to result in rotation of the component 42 in an opposed direction from that desired. That is, the spring forces can relax and drive the component away from the desired positon. At step 60, should a pulse be sensed which is opposite to a desired direction, it is subtracted from the count.

Of course, the terms “add” and “subtract” would be dependent upon the desired direction. In some operations, rotation may be desired in say a counterclockwise direction such that the opposed movement would be clockwise. In other operations, it might be that the desired movement is clockwise, such that the “unwinding” would be counterclockwise. At any rate, the steps 56 and 60 result in an accurate understanding of what should be the actual position of the component 42 to a more accurate degree than has been the case in the past.

As shown in FIG. 3 at step 70, the count is comparted to an expected position count. The question is asked is the difference between the actual count and the expected position count greater than a predetermined value X. If not, then no action is taken. On the other hand, should the difference exceed the predetermined value X, then a calibration step 72 is taken.

The value X may be selected to ensure there is not too much difference between actual and expected positions of the valve.

FIG. 1A also shows one embodiment of a calibration step. An item 80 on the component 42 is driven back against the stop 82. This then provides a zero position for the component 80 and the system can then move to drive the component 42 back towards a desired position, which becomes the expected position.

It should be understood that the differences between the expected and actual position can build up over time and such a calibration step would remove that buildup, such that the actual position would become closer to the expected position.

FIG. 1B shows another embodiment wherein a shaft 84, which may be either the shaft 32 or 38 from the FIG. 1A system is provided with a permanent magnet 86. A sensor 88, which may be a Hall effect device, looks for the position of the magnet 86 and utilizes this position to again zero out or calibrate the location of the component 42 in the control 40. Then, the component 42 can be driven back toward a desired position.

Although an embodiment of this invention has been disclosed, a worker of ordinary skill in this art would recognize that certain modifications would come within the scope of this invention. For that reason, the following claims should be studied to determine the true scope and content of this invention.

1. An electromechanical system comprising:
a component to be positioned;
a rotary permanent magnet motor for positioning said component;
sensors for determining an apparent position of said component based upon rotation of said permanent magnets; and
a control sensing movement of said permanent magnets past said sensors in a desired direction, and also rotation of said permanent magnets past said sensors in an undesired direction when said motor is stopped, and preparing a count of an actual position of said component based upon both of said rotations, said control also comparing said actual position to an expected position for said component and identifying a need to calibrate should a difference between said actual and expected positions differ by more than a determined amount.

2. The electromechanical system as set forth in claim 1, wherein said component is a valve.

3. The electromechanical system as set forth in claim 1, wherein said sensors are Hall effect sensors.

4. The electromechanical system as set forth in claim 1, wherein said component is mounted on a space vehicle.

5. The electromechanical system as set forth in claim 1, wherein said control is programmed to determine whether a pulse from each of said sensors is either an invalid pulse, an actual pulse in said desired direction, or an actual pulse in said undesired direction.

6. The electromechanical system as set forth in claim 1, wherein said permanent magnet motor driving a first shaft having a first gear, said first gear driving at least a second gear to, in turn, drive a second shaft which moves said component in a rotary direction, with said first and second gears changing a speed between said first and second shafts.

7. The electromechanical system as set forth in claim 6, wherein each of said first and second shafts and gear teeth between said first and second gears having a spring force which may result in rotation in said undesired direction when said motor is stopped.

8. The electromechanical system as set forth in claim 1, wherein if said calibration is deemed needed, a surface on said component is driven against a stop to provide a new expected position in said control for said component.

9. The electromechanical system as set forth in claim 1, wherein if said calibration is deemed needed, a sensor senses a location of a feature, and the location of said feature being utilized to provide a new expected position in said control for said component.

10. The electromechanical system as set forth in claim 9, wherein said feature is a permanent magnet.

11. A method comprising the steps of:
driving a rotary permanent magnet motor for positioning a component;
sensors determining an apparent position of said component based upon rotation of said permanent magnets past said sensor; and
sensing movement of said permanent magnets past said sensors in a desired direction, and also rotation of said permanent magnets past said sensors in an undesired direction when said motor is stopped, and preparing a count of an actual position of said component based upon both of said rotation directions, and comparing said actual position to an expected position of said component and identifying a need to calibrate should a difference between said calculated and expected positions differ by more than a determined amount.

12. The method as set forth in claim 1, wherein said component is a valve.

13. The method as set forth in claim 1, wherein said sensors are Hall effect sensors.

14. The method as set forth in claim 1, wherein said component is mounted on a space vehicle.

15. The method as set forth in claim 1, wherein a control determining if a pulse from each of said sensors is either an invalid pulse, an actual pulse in said desired direction, or an actual pulse in said undesired direction.

16. The method as set forth in claim 11, wherein said permanent magnet motor driving a first shaft having a first gear, said first gear driving at least a second gear to, in turn, drive a second shaft which moves said component in a rotary direction, with said first and second gears changing a speed between said first and second shafts.

17. The method as set forth in claim 16, wherein each of said first and second shafts and gear teeth between said first and second gears having a spring force which may result in rotation in said undesired direction when said motor is stopped.

18. The method as set forth in claim 11, wherein if said calibration is needed, driving a surface on said component against a stop to provide a new expected position.

19. The method as set forth in claim 11, wherein if said calibration is needed, sensing a location of a feature, and the location of said feature being utilized to provide a new expected position.

20. The method as set forth in claim 19, wherein said feature is a permanent magnet on one of said first and second shafts.
